(19) United States
(12) Patent Application Publication
(10) Pub. No.: US 2026/0168716 A1
(43) Pub. Date: Jun. 18, 2026

(54) ICE WATER PURIFIER

(71) Applicant: COWAY Co., Ltd., Gongju-si (KR)

(72) Inventors: Chung Lae KIM, Seoul (KR); Hyun Woo LEE, Seoul (KR)

(73) Assignee: COWAY Co., Ltd., Gongju-si (KR)

(21) Appl. No.: 19/403,967

(22) Filed: Nov. 30, 2025

(30) Foreign Application Priority Data
Dec. 18, 2024 (KR) 10-2024-0190387

(51) Int. Cl. F25C 5/182; F25C 1/25

(52) U.S. Cl. CPC F25C 5/182; F25C 1/25; F25C 2400/12; F25C 2400/14; F25C 2700/14

(57) ABSTRACT

An ice water purifier includes a filter unit, an ice-making unit, an ice storage unit and a cooling flow unit. The filter unit is configured to receive raw water and generate purified water. The ice-making unit is configured to generate ice using the purified water generated by the filter unit. The ice storage unit is configured to store the ice generated by the ice-making unit. The cooling flow unit is configured to extend along an outer surface of the ice storage unit and to receive cooling water that remains stagnant or flows within an interior thereof.

This application claims priority under 35 U.S.C. § 119 to Korean Patent Application No. 10-2024-0190387, filed on Dec. 18, 2024, the disclosure of which is incorporated by reference herein in its entirety.

### BACKGROUND OF THE INVENTION

### Technical Field

The present invention relates to an ice water purifier, and more particularly, to an ice water purifier having improved insulation performance that enhances the thermal insulation and cooling retention of an ice storage unit, minimizes heat intrusion, and increases the preservation of stored ice.

### Discussion of the Related Art

In the ice storage unit of an ice water purifier, it is necessary to preserve the ice stored therein for a relatively long period without melting. Accordingly, various techniques have been developed to improve the preservation performance of the ice stored in the ice storage unit.

For example, Korean Patent No. 10-2630821 discloses a technique in which the exterior of a storage container, including an ice storage unit, is covered with a heat-insulating material in order to provide thermal insulation or cooling retention for the storage container. In addition, Korean Laid-Open Patent Publication No. 10-2022-0030127 discloses a technique related to an integrated tank having a thermal insulation structure, in which a foamed insulation material is formed on an outer circumferential surface of the tank to enhance insulation performance.

As described above, conventional techniques have mainly improved insulation performance by covering or filling the exterior of the ice storage unit with heat-insulating materials or foamed insulation materials.

However, in recent years, the number of holes formed in the ice storage unit for hygiene or sensing purposes has increased, which increases heat intrusion. Therefore, simply improving insulation performance through filling-type structures has reached its limit.

### SUMMARY

Accordingly, the technical task of the invention is derived from these points, and exemplary embodiments of the present invention provide an ice water purifier with improved insulation performance that enhances the thermal insulation and cooling retention of an ice storage unit, minimizes heat intrusion, and increases the preservation of stored ice.

According to one aspect of the present invention, an ice water purifier includes a filter unit, an ice-making unit, an ice storage unit and a cooling flow unit. The filter unit is configured to receive raw water and generate purified water. The ice-making unit is configured to generate ice using the purified water generated by the filter unit. The ice storage unit is configured to store the ice generated by the ice-making unit. The cooling flow unit is configured to extend along an outer surface of the ice storage unit and to receive cooling water that remains stagnant or flows within an interior thereof.

In an example, the cooling flow unit may be configured to extend in a zigzag pattern along the outer surface.

In an example, the ice storage unit may include a first side and a second side that face each other in a first direction, and a third side and a fourth side that face each other in a second direction.

In an example, the cooling flow unit may be configured to extend continuously along at least two of the first side through the fourth side.

In an example, the cooling flow unit may include an inlet formed on any one of the first side through the fourth side and configured to allow the cooling water to flow in, and an outlet formed on remaining one of the first side through the fourth side and configured to allow the cooling water to flow out.

In an example, the cooling flow unit may extend continuously only along any one of the first side through the fourth side, and an inlet configured to receive the cooling water and an outlet configured to discharge the cooling water may be simultaneously formed on the same side.

In an example, the ice storage unit may further include a fin portion formed on the side of the first side through the fourth side on which the cooling flow unit is formed such that the fin portion contacts the cooling flow unit.

In an example, the ice water purifier may further include a filling portion configured to cover the ice storage unit on which the cooling flow unit is formed.

In an example, the filling portion may include a vacuum portion configured to maintain the cooling flow unit in a vacuum state, or insulation material configured to cool the cooling flow unit, or an insulation portion configured to contact the cooling flow unit and insulation material configured to cover an outer surface of the insulation portion.

In an example, the ice water purifier may further include a drain tank configured to store remaining ice-making water drained from the ice storage unit.

In an example, the ice water purifier may further include a water level sensor unit configured to measure a water level of the drain tank. An amount of the remaining ice-making water provided to the cooling flow unit may be controlled based on the water level of the drain tank.

In an example, the cooling water may be any one of, the remaining ice-making water drained from the ice storage unit, cold water provided through the cold-water supply unit, and raw water provided through the raw-water supply unit.

In an example, the cold water of the cold-water supply unit may pass through the drain tank and be provided to the cooling flow unit.

In an example, the raw water of the raw-water supply unit may pass through the drain tank and be provided to the cooling flow unit.

In an example, the ice water purifier may further include a first valve configured to control supply of the ice-making water, a second valve configured to control supply of the cold water, and a third valve configured to control supply of the raw water.

In an example, the ice-making water, the cold water, and the raw water may be selectively provided through control of a four-way valve.

In an example, the cooling water may be intermittently provided to the cooling flow unit.

In an example, the ice water purifier may further include a first sensor unit configured to measure a temperature of the ice storage unit, and a second sensor unit configured to measure a temperature of the remaining ice-making water in the drain tank. When the temperature of the remaining ice-making water is lower than the temperature of the ice storage unit, the remaining ice-making water may be provided to the cooling flow unit.

In an example, the ice water purifier may further include a third sensor unit configured to measure a temperature of the cold water of the cold-water supply unit. When the temperature of the cold water is lower than the temperature of the ice storage unit and the temperature of the ice-making water, the cold water may be provided to the cooling flow unit.

In an example, the ice water purifier may further include a fourth sensor unit configured to measure a temperature of the raw water of the raw-water supply unit. When the temperature of the raw water is lower than the temperature of the ice storage unit, the temperature of the ice-making water, and the temperature of the cold water, the raw water may be provided to the cooling flow unit.

According to exemplary embodiments of the present invention, a cooling flow unit is formed along an outer surface or side surfaces of the ice storage unit in which ice is stored, and as cooling water having a relatively low temperature flows through the cooling flow unit, the insulation effect of the ice storage unit may be improved through direct cooling.

Accordingly, compared to techniques that merely fill or cover the exterior of the ice storage unit with insulation material, the ice water purifier enables more direct cooling or insulation, and even when various structures or holes are formed in the ice storage unit and heat intrusion increases, the cooling or insulation effect may still be enhanced.

In this case, the cooling flow unit may extend in a zigzag pattern so as to contact a larger surface area of the ice storage unit, and the cooling water may be introduced from a side having a relatively higher temperature, thereby increasing the insulation effect through cooling of the higher-temperature region.

In addition, the cooling flow unit may extend across at least two of the side surfaces of the ice storage unit to form a single flow path, allowing the inflow and outflow of the cooling water to be controlled in a simplified manner. Alternatively, an independent cooling flow unit may be formed on each side surface, thereby improving ease of installation of the cooling flow unit.

Further, when a filling portion is additionally formed outside the cooling flow unit, the cooling energy provided through the cooling flow unit may be guided toward the ice storage unit rather than outward, thereby further enhancing the insulation effect. The filling portion may include a vacuum portion, insulation material, or an insulation structure, allowing the filling portion to be optimized according to various structural configurations. Particularly, by forming a fin portion on the outer surface of the ice storage unit to increase the contact area with the cooling flow unit, the transfer efficiency of cooling energy to the ice storage unit may be further improved.

Meanwhile, the cooling water supplied to the cooling flow unit may selectively be ice-making water, cold water, or raw water, allowing cooling water of the lowest available temperature to be provided depending on the usage state or season, thereby improving energy efficiency.

Notably, in selecting among the ice-making water, cold water, and raw water, temperatures measured by sensor units provided in the drain tank, the cold-water supply unit, and the raw-water supply unit may be compared with the temperature of the ice storage unit, so that the cooling water having the lowest temperature can be selected.

Additionally, a water level sensor unit may be provided in the drain tank so that the amount of cooling water supplied to the cooling flow unit may be appropriately controlled based on the water level of the drain tank.

The cold-water supply unit may be a cold-water tank that stores cold water or may be a direct-cooling type or an ice-storage type that directly produces and supplies cold water, allowing the cold water to be used as cooling water regardless of the cold-water supply structure of the purifier.

In this case, when the cold-water supply unit is a direct-cooling or ice-shaft type, no separate pump unit is included in the cold-water supply unit. Thus, by bypassing the cold water so that it passes through the drain tank before being supplied as cooling water, the cooling water may be supplied through a pump unit provided in the drain tank, eliminating the need for a separate pump unit in the cold-water supply unit.

Furthermore, the supply of the ice-making water, cold water, or raw water may be controlled through separate valves, or may alternatively be selectively controlled through a single four-way valve, allowing various piping system configurations and improving design flexibility.

### BRIEF DESCRIPTION OF THE DRAWINGS

FIG. 1 is a schematic view illustrating an ice water purifier according to an example embodiment of the present invention;

FIG. 2 is a perspective view illustrating an example of the ice storage unit and the ice-making unit provided with the cooling flow unit of FIG. 1;

FIG. 3A to FIG. 3D are examples of cross-sectional views taken along line I-I′ of FIG. 2;

FIG. 4 is a perspective view illustrating another example of the ice storage unit and the ice-making unit provided with the cooling flow unit of FIG. 1;

FIG. 5 is a schematic view illustrating an ice water purifier according to another example embodiment of the present invention;

FIG. 6 is a schematic view illustrating an ice water purifier according to still another example embodiment of the present invention;

FIG. 7 is a schematic view illustrating an ice water purifier according to still another example embodiment of the present invention; and

FIG. 8 is a schematic view illustrating an ice water purifier according to still another example embodiment of the present invention.

### DETAILED DESCRIPTION OF THE INVENTION

The present invention may be modified in various ways and may take different forms, therefore, specific embodiments will be described in detail in the specification. However, the disclosure is not intended to limit the invention to the particular forms described, and it should be understood to include all modifications, equivalents, and alternatives that fall within the spirit and scope of the invention. In the drawings, similar reference numerals designate corresponding elements, and terms such as “first,” “second,” etc. are merely used to distinguish one element from another, and are not intended to limit the scope of the invention.

The terminology used in the present application is for the purpose of describing particular embodiments only, and is not intended to limit the invention. Unless the context clearly indicates otherwise, the singular forms include the plural. As used herein, the terms “include” and “consist of” indicate the presence of features, numerals, steps, operations, elements, parts, or combinations thereof described in the specification, but do not preclude the possibility of the presence or addition of one or more other features, numerals, steps, operations, elements, parts, or combinations thereof.

Hereinafter, the present invention will be explained in detail with reference to the accompanying drawings.

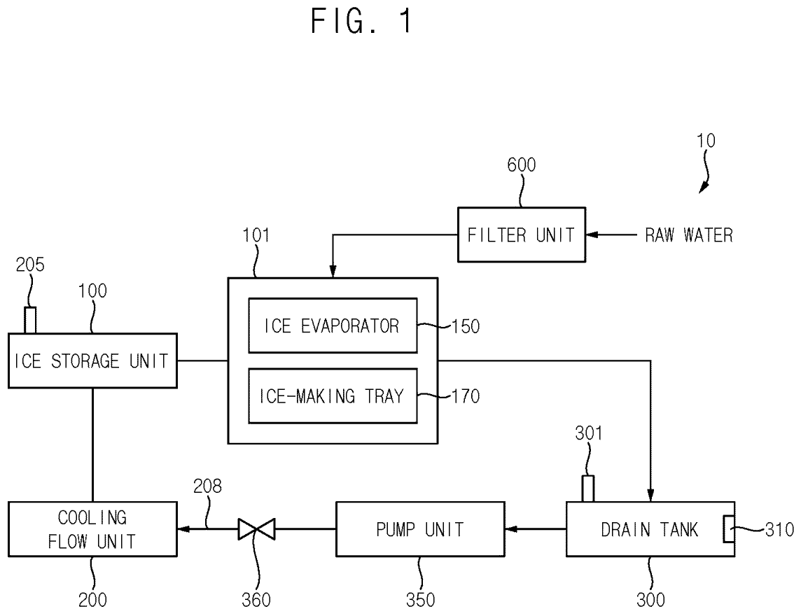

FIG. 1 is a schematic view illustrating an ice water purifier according to an example embodiment of the present invention.

Referring to FIG. 1, an ice water purifier 10 according to the present example embodiment includes an ice storage unit 100, an ice-making unit 101, a cooling flow unit 200, a drain tank 300, a pump unit 350, a first valve 360, and a filter unit 600.

The ice storage unit 100 stores the ice that has been produced and defines a predetermined internal space, and the cooling flow unit 200 is formed on the outside thereof. The ice-making unit 101 may be provided in the internal space formed by the ice storage unit 100, and details thereof will be described later.

Since ice is stored inside the ice storage unit 100, the interior of the ice storage unit 100 must be maintained at a relatively low temperature in order to keep the ice in a stable, non-melting state for an extended period of time. Therefore, heat loss to the outside must be minimized. In the present example embodiment, cooling energy is supplied from the cooling flow unit 200 formed outside the ice storage unit 100 to cool or insulate the ice storage unit 100.

The cooling flow unit 200 is formed on the exterior of the ice storage unit 100 and may have a conduit structure through which cooling water 208 flows. The cooling water 208 flowing into the interior of the cooling flow unit 200 need not necessarily flow continuously, and the cooling water 208 may remain stagnant for a predetermined time to achieve cooling or insulation.

The cooling flow unit 200 may be, for example, an injection-molded tube or a metal conduit. The cooling water 208 may either flow through the cooling flow unit 200 or remain inside it. When the cooling water 208 has a relatively low temperature, cooling energy is transferred through the cooling flow unit 200 to the ice storage unit 100, enabling cooling or insulation of the ice storage unit 100.

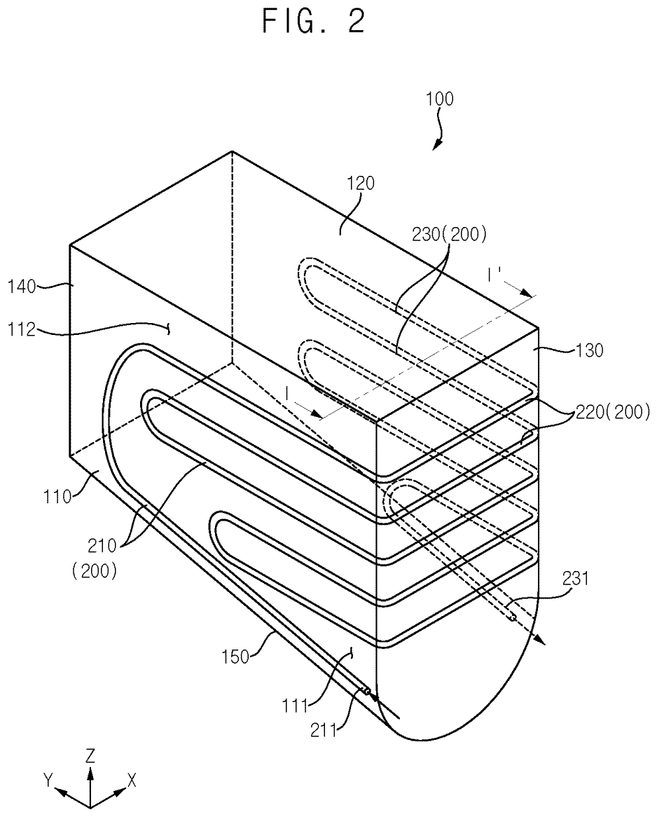

The ice-making unit 101 produces ice and may be provided in an upper space 112 (see FIG. 2) of the internal space formed by the ice storage unit 100. In other words, the ice storage unit 100 and the ice-making unit 101 store and produce ice, respectively, and the ice-making unit 101 may be disposed in an upper space of the single container or tank structure forming the ice storage unit 100. Alternatively, the ice storage unit 100 and the ice-making unit 101 may be disposed in individually partitioned compartments or may be completely separated into independent containers.

The ice-making unit 101 includes an ice evaporator 160 and an ice-making tray 170. The ice evaporator 160 receives coolant that has been cooled to a low-temperature, low-pressure state through a refrigeration cycle, and thereby cools the purified water (ice-making water) supplied to the ice-making tray 170 to form ice. The purified water is generated by filtering raw water supplied from outside through the filter unit 600, and may be cooled by a cold-water supply unit after filtration.

After ice formation, the ice in the ice-making tray 170 falls or moves into the ice storage unit 100 and is stored therein.

During the process in which ice falls or moves from the ice-making tray 170, ice-making water that has not been frozen is guided through a separate drain pipe formed at the lower portion of the ice storage unit 100 and delivered to the drain tank 300. In addition, any remaining ice-making water left after ice formation is also delivered to the drain tank 300.

Thus, the remaining ice-making water drained to the drain tank 300 has a relatively low temperature. In the present example embodiment, the remaining ice-making water stored in the drain tank 300 is reused as the cooling water 208 supplied to the cooling flow unit 200.

Conventionally, the remaining ice-making water in the drain tank 300 would simply be discarded. However, by reusing the remaining ice-making water as the cooling water 208 as in the present example embodiment, the remaining ice-making water may be recycled, thereby improving energy efficiency.

The pump unit 350 is provided in the pipe connecting the drain tank 300 to the cooling flow unit 200 and supplies the remaining ice-making water stored in the drain tank 300 to the cooling flow unit 200.

A first valve 360 is provided between the pump unit 350 and the cooling flow unit 200. By opening and closing the first valve 360, the remaining ice-making water in the drain tank 300 may be selectively supplied to the cooling flow unit 200.

In other words, in order for the cooling flow unit 200 to cool or insulate the ice storage unit 100, the remaining ice-making water stored in the drain tank 300 must have a lower temperature than the temperature of the ice storage unit 100. Therefore, the first valve 360 is controlled such that the ice-making water is supplied only when the temperature of the remaining ice-making water is lower than the temperature of the ice storage unit 100.

To perform the above, a first sensor unit 205 is provided in the ice storage unit 100 where the cooling flow unit 200 is formed, and a second sensor unit 301 is provided in the drain tank 300. The first sensor unit 205 may be provided between the flow channels of the cooling flow unit 200 or inside the ice storage unit 100.

The first sensor unit 205 measures the temperature of the ice storage unit 100, and the second sensor unit 301 measures the temperature of the drain tank 300, that is, the temperature of the ice-making water. Thus, when the ice-making water is lower in temperature than the ice storage unit 100, the first valve 360 is opened so that the remaining ice-making water in the drain tank 300 is supplied to the cooling flow unit 200.

A water level sensor unit 310 may be provided in the drain tank 300.

The water level sensor unit 310 measures the water level in the drain tank 300. Typically, the water level sensor unit 310 includes a full-level sensor and a low-level sensor that detect whether the tank is full or low. However, when only the full-level sensor and the low-level sensor are used, it is difficult to accurately determine the current water level or the amount of ice-making water in the drain tank 300. Consequently, it is difficult to accurately predict the amount of cooling water supplied from the drain tank 300 to the cooling flow unit 200.

In particular, when the water level is close to full but not detected by the full-level sensor, if cooling water is supplied from the drain tank 300 to the cooling flow unit 200 until the low-level sensor is triggered, the amount of cooling water supplied at one time may be excessively large.

Therefore, in the present example embodiment, the water level sensor unit 310 further includes a mid-level sensor that measures an intermediate water level between the full and low water levels. Based on the detection results of the full-level sensor and the mid-level sensor, the cooling water 208 corresponding to the volume between the full and mid-level may be supplied to the cooling flow unit 200 at once. Likewise, based on the results of the mid-level sensor and the low-level sensor, cooling water 208 corresponding to the volume between the mid and low water levels may also be supplied once. As a result, an appropriate amount of cooling water may be supplied to the cooling flow unit 200 using the mid-level sensor.

Furthermore, although a single mid-level sensor is described, multiple mid-level sensors may be provided between the full-level sensor and the low-level sensor, allowing various water levels to be detected. This enables more precise control of the amount of cooling water supplied to the cooling flow unit 200.

FIG. 2 is a perspective view illustrating an example of the ice storage unit and the ice-making unit provided with the cooling flow unit of FIG. 1.

Hereinafter, although the ice storage unit 100 is described as being formed as a single chamber or tank as an example, its structure may be variously modified as described above.

More specifically, referring to FIG. 2, the ice storage unit 100 has a structure such as a chamber or tank that defines a predetermined internal space, and includes a pair of first and second side surfaces 110 and 120 facing each other in a first direction X, a pair of third and fourth side surfaces 130 and 140 facing each other in a second direction Y perpendicular to the first direction X, and an inclined surface 150 that forms the bottom surface of the ice storage unit 100.

That is, the third side surface 130 connects one side of the first and second side surfaces 110 and 120, and the fourth side surface 140 connects the other side of the first and second side surfaces 110 and 120. The inclined surface 150 is formed along the bottom surfaces of the first through fourth side surfaces 110, 120, 130, and 140, and may be inclined in one direction, as shown. In addition, the ice storage unit 100 includes an upper surface 120, such that the entire structure forms a sealed chamber.

A lower space 111 in which the inclined surface 150 is formed (not illustrated) corresponds to the ice storage space in which ice is stored, and the stored ice may be discharged to the outside as necessary.

As described above, although not shown in the drawings, the ice-making unit 101 may be provided in an upper space 112 of the ice storage unit 100. After ice is produced by the ice evaporator 160 and the ice-making tray 170, the ice may fall into the lower space 111 of the ice storage unit 100 and be stored therein.

The cooling flow unit 200 is formed to extend along an outer surface of the ice storage unit 100. As shown, it extends along the first side surface 110, the third side surface 130, and the second side surface 120.

That is, the cooling flow unit 200 includes a first flow path 210 extending along the first side surface 110, a second flow path 220 extending along the third side surface 130, and a third flow path 230 extending along the second side surface 120. The first through third flow paths 210, 220, and 230 extend continuously, as illustrated.

In this case, an inlet 211 is formed at the lower side of the first side surface 110 so that the cooling water 208 flows in. An outlet 231 is formed at the lower side of the second side surface 120 so that the cooling water 208 flows out. Thus, the cooling water 208 introduced through the inlet 211 cools the first side surface 110 while passing through the first flow path 210, cools the third side surface 130 while passing through the second flow path 220, and cools the second side surface 120 while passing through the third flow path 230, and is then discharged through the outlet 231.

The first through third flow paths 210, 220, and 230 may extend in a zigzag shape along the first through third side surfaces 110, 120, and 130. That is, the cooling flow unit 200 overall begins extending from the lower side of the first side surface 110, extends upward along the inclined surface 150, then extends from the upper side of the first side surface 110 to the upper sides of the third side surface 130 and the second side surface 120. Thereafter, at the second side surface 120, the direction is changed, and the flow unit extends along the central regions of the second, third, and first side surfaces 120, 130, and 110. The direction is then changed again, and the cooling flow unit 200 extends along the first, third, and second side surfaces 110, 130, and 120. Finally, it extends along the lower sides of the first through third side surfaces 110, 120, and 130, and reaches the outlet 231 at the lower side of the second side surface 120.

As described, the cooling flow unit 200 extends in a zigzag pattern overall, contacting the first through third side surfaces 110, 120, and 130 multiple times. The number of times the cooling flow unit 200 contacts these surfaces may vary, and the positions where the unit extends or changes direction may be variously designed.

In the present example embodiment, the inlet 211 is formed in the first side surface 110 so that the lowest-temperature cooling water 208 first flows into the lower side of the first side surface 110. This is because, when the ice storage unit 100 is mounted inside the ice water purifier 10, the first side surface 110 is positioned adjacent the outer surface of the purifier and therefore receives a significant amount of external heat. Furthermore, the lower portion corresponds to the lower space 111 where ice is stored, which requires the greatest insulation and cooling.

However, the positions of the inlet 211 and outlet 231 may be variably determined depending on design considerations, such as where external heat intrusion is greatest or where cooling is most needed.

While the drawings illustrate an example in which the cooling flow unit 200 is not formed on the fourth side surface 140, the cooling flow unit 200 may additionally extend to the fourth side surface 140.

Although FIG. 2 illustrates the ice storage unit 100 as having a rectangular block shape, the outer shape of the ice storage unit 100 is not limited thereto. Accordingly, when the ice storage unit 100 has other shapes—such as a cylindrical shape, various polygonal prism shapes, or various block shapes—the cooling flow unit 200 may be formed along the outer surface of the ice storage unit 100 in any structure derivable from the configuration described with reference to FIG. 2.

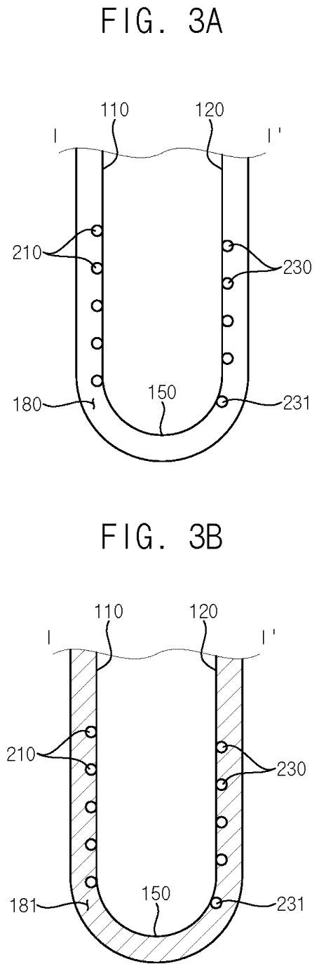

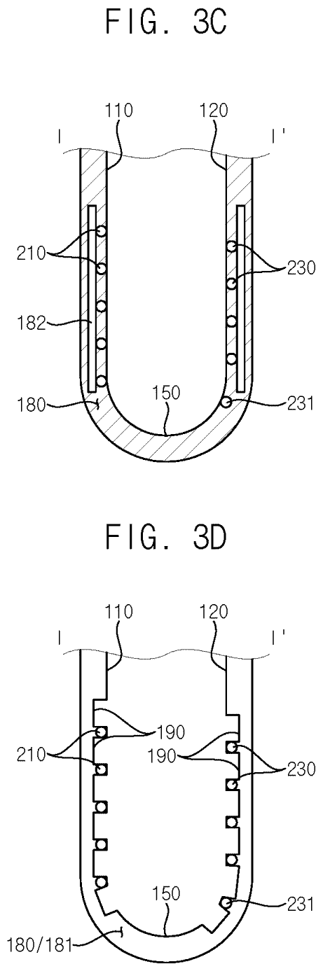

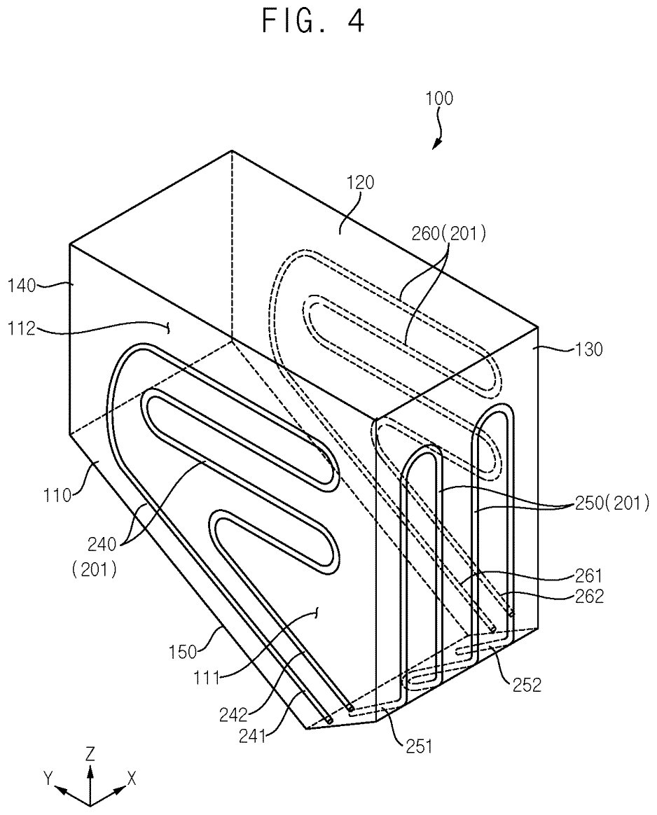

As described above, the cooling flow unit 200 is formed in direct contact with the outer surface of the ice storage unit 100, thereby enhancing cooling and thermal insulation of the ice storage unit 100. However, to minimize loss of cooling energy to the outside, a filling portion may be formed outside the cooling flow unit 200. Accordingly, with reference to FIG. 3A through FIG. 3D, specific examples of the filling portion will now be described.

FIG. 3A to FIG. 3D are examples of cross-sectional views taken along line I-I′ of FIG. 2.

First, referring to FIG. 3A, the filling portion 180 may be a vacuum portion. That is, a vacuum space having a predetermined thickness may be formed outside the ice storage unit 100 where the cooling flow unit 200 is formed, thereby constituting the filling portion 180. As a result, the insulation effect with respect to the cooling flow unit 200 is enhanced, and the cooling energy provided from the cooling flow unit 200 is directed only toward the ice storage unit 100.

Referring to FIG. 3B, the filling portion 181 may be insulation material. That is, insulation material having a predetermined thickness may be formed outside the ice storage unit 100 where the cooling flow unit 200 is formed, thereby constituting the filling portion 181. The insulation material may be a foamed insulation material, which enhances the insulation effect with respect to the cooling flow unit 200 and ensures that the cooling energy provided from the cooling flow unit 200 is delivered only to the ice storage unit 100.

Referring to FIG. 3C, the filling portion may be composed of an insulation portion 182 and insulation material 181 covering the outside of the insulation portion 182. That is, an insulation portion 182 having a vacuum structure may be disposed in contact with the outside of the cooling flow unit 200, and insulation material 181 may be formed with a predetermined thickness to cover the outside of the insulation portion 182, thereby forming the filling portion.

Through the insulation portion 182 having a vacuum structure, heat transferred outward from the cooling flow unit 200 may be minimized, thereby inducing cooling energy to be directed toward the ice storage unit 100. The insulation material 181, formed as foamed insulation material of a predetermined thickness, further enhances the insulation effect with respect to the cooling flow unit 200.

Referring to FIG. 3D, a fin portion 190 is formed on an outer circumferential surface of the ice storage unit 100 in order to improve heat transfer performance of the cooling flow unit 200. As illustrated, the fin portion 190 may have a structure that protrudes from the outer circumferential surface of the ice storage unit 100 at predetermined intervals so that it is positioned between the individual pipes of the cooling flow unit 200.

Accordingly, the cooling flow unit 200 contacts not only the outer surface of the ice storage unit 100 but also the fin portion 190 simultaneously, thereby increasing the overall contact area with the ice storage unit 100 and further improving the rate at which cooling energy is transferred to the ice storage unit 100.

The fin portion 190 may be separately manufactured and mounted on the outer circumferential surface of the ice storage unit 100, or it may be integrally formed with the ice storage unit 100 through injection molding during the manufacturing process.

Additionally, with the cooling flow unit 200 extending between the fin portions 190, a filling portion 180 or 181 may be further formed outside the cooling flow unit 200 with a predetermined thickness. As described with reference to FIG. 3A and FIG. 3B, the filling portion may be the vacuum portion 180 or the insulation material 181. As a result, heat transfer toward the ice storage unit 100 may be further improved.

FIG. 4 is a perspective view illustrating another example of the ice storage unit and the ice-making unit provided with the cooling flow unit of FIG. 1.

In the example, the cooling flow unit 201 formed in the ice storage unit 100 includes first through third flow paths 240, 250, and 260, which are independently formed on the first through third side surfaces 110, 120, and 130 without being connected to one another.

That is, in the ice storage unit 100 having the same structure as in FIG. 2, the first flow path 240 is formed on the first side surface 110, the second flow path 250 is formed on the third side surface 130, and the third flow path 260 is formed on the second side surface 120.

As described above, since the first through third flow paths 240, 250, and 260 are independently formed on respective side surfaces, each flow path includes its own inlet and outlet.

In the case of the first flow path 240, a first inlet 241 is formed at the lower side of the first side surface 110, and a first outlet 242 is formed at the lower side of the first side surface 110 adjacent to the first inlet 241. Thus, the first flow path 240 extends upward from the first inlet 241 along the inclined surface 150, then extends downward along the first side surface 110 in a zigzag shape, and is finally connected to the first outlet 242.

In the first flow path 240 as well, the first inlet 241 is formed at the lower side of the first side surface 110 so that the lowest-temperature ice-making water 208 may first flow toward the space where ice is stored, thereby improving the preservation state of the ice. The direction, length, pattern, and shape in which the first flow path 240 extends may be variously modified.

In the case of the second flow path 250, a second inlet 251 is formed at the lower side of the third side surface 130, and a second outlet 252 is also formed at the lower side of the third side surface 130. Thus, the second flow path 250 extends upward from the second inlet 251 along the third side surface 130, then extends downward in a zigzag shape along the third side surface 130, and is connected to the second outlet 252.

Similarly, in the second flow path 250, the second inlet 251 is formed at the lower side of the third side surface 130 so that the lowest-temperature ice-making water 208 may first flow toward the ice storage space. The direction, shape, and pattern of the second flow path 250 may also be variously modified.

In the case of the third flow path 260, a third inlet 261 is formed at the lower side of the second side surface 120, and a third outlet 262 is formed adjacent to the third inlet 261 at the lower side of the second side surface 120. Thus, the third flow path 260 extends upward from the third inlet 261 along the inclined surface 150, then extends downward in a zigzag pattern along the second side surface 120, and is then connected to the third outlet 262.

In the third flow path 260 as well, the third inlet 261 is formed at the lower side of the second side surface 120 so that the lowest-temperature ice-making water 208 may first flow toward the ice storage space. The direction, shape, and pattern of the third flow path 260 may also be variously modified.

Although the drawings illustrate an example where no flow path is formed on the fourth side surface 140, a flow path similar to that on the third side surface 130 may also be formed on the fourth side surface 140.

As described above, the cooling flow unit 201 may extend independently on each side surface of the ice storage unit 100 such that cooling water 208 flows in and out independently for each side surface. Accordingly, cooling and thermal insulation may be independently controlled for each side surface.

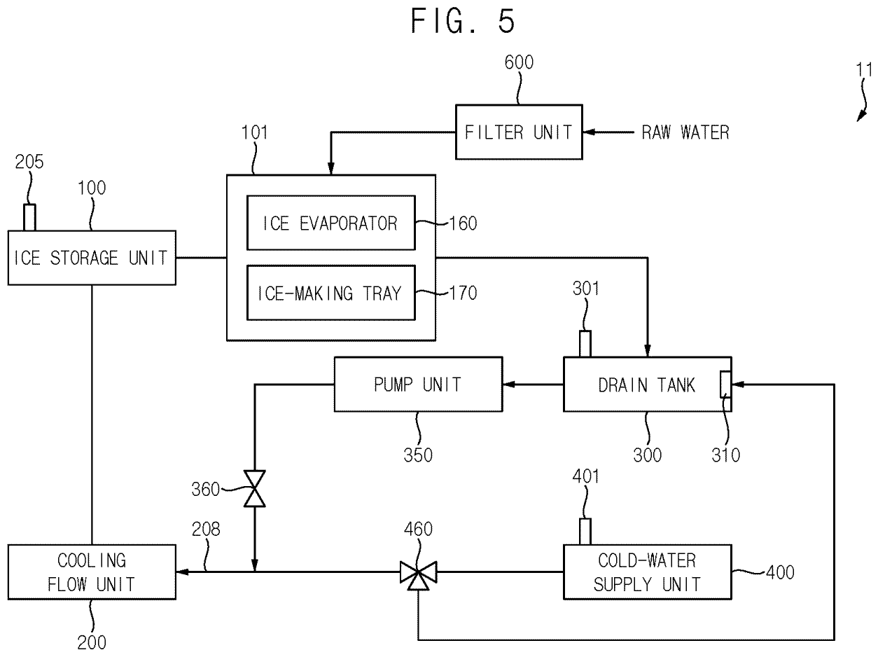

FIG. 5 is a schematic view illustrating an ice water purifier according to another example embodiment of the present invention.

The ice water purifier 11 according to the present example embodiment is substantially the same as the ice water purifier 10 described with reference to FIG. 1, except that a cold-water supply unit 400 is additionally provided. Therefore, the same reference numerals are used for identical components, and redundant descriptions will be omitted.

Referring to FIG. 5, in the ice water purifier 11 according to the present example embodiment, cold water may also be selectively provided as the ice-making water 208 through the cold-water supply unit 400.

The cold-water supply unit 400 may include, for example, a separate cold-water tank, and the cold water stored in the cold-water tank may be supplied as the ice-making water 208. Alternatively, the cold-water supply unit 400 may supply cold water directly as the ice-making water 208, such as in a direct-cooling type or an ice-shaft type cold-water supply system. Since such direct-cooling or ice-shaft structures are commonly used in conventional water purifiers, detailed descriptions thereof will be omitted.

The cold-water supply unit 400 includes a third sensor unit 401, which measures the temperature of the cold water provided from the cold-water supply unit 400. Based on the temperature of the ice storage unit 100 measured by the first sensor unit 205, the temperature of the remaining ice-making water measured by the second sensor unit 301, and the temperature of the cold water measured by the third sensor unit 401, the water to be supplied as the cooling water 208 is determined.

That is, if the temperature of the ice storage unit 100 is the lowest, the supply of cooling water may be omitted, and the first valve 360 and a second valve 460 provided between the cold-water supply unit 400 and the cooling flow unit 200 are shut off.

If the remaining ice-making water has the lowest temperature, the first valve 360 is opened while the second valve 460 is shut off, so that the remaining ice-making water is supplied to the cooling flow unit 200.

Conversely, if the cold water has the lowest temperature, the first valve 360 is shut off and the second valve 460 is opened so that the cold water is supplied to the cooling flow unit 200.

As shown, the second valve 460 may be, for example, a three-way valve. Thus, the cold water of the cold-water supply unit 400 may be supplied directly to the cooling flow unit 200 or may bypass the drain tank 300 before being supplied to the cooling flow unit 200.

As described above, the cold-water supply unit 400 may include a cold-water tank that stores cold water, and in such structures, the cold-water tank itself may include a pump unit, enabling cold water to be supplied directly from the cold-water tank to the cooling flow unit 200. Accordingly, in structures including a cold-water tank, the second valve 460 opens the flow path toward the cooling flow unit 200 so that the cold water may be directly supplied from the cold-water supply unit 400 to the cooling flow unit 200.

Alternatively, when the cold-water supply unit 400 is a direct-cooling or ice-storage type, it does not include a separate pump unit, and cold water flows due to the supply pressure of raw water supplied from outside. In regions where raw water pressure is sufficiently high, cold water may be selectively supplied to the cooling flow unit 200 when cooling is required. However, in regions where raw water pressure is low, the second valve 460 opens the flow path toward the drain tank 300 so that cold water is supplied from the cold-water supply unit 400 to the drain tank 300, and the pump unit 350 provided in the drain tank 300 supplies the cold water to the cooling flow unit 200. For this purpose, the first valve 360 must also be opened when cold water is supplied.

As described above, in the present example embodiment, when the remaining ice-making water or the cold water has a lower temperature than the temperature of the ice storage unit 100, the water having the lower temperature between the remaining ice-making water and the cold water is supplied as the cooling water 208, thereby further enhancing the cooling and insulation performance with respect to the ice storage unit 100.

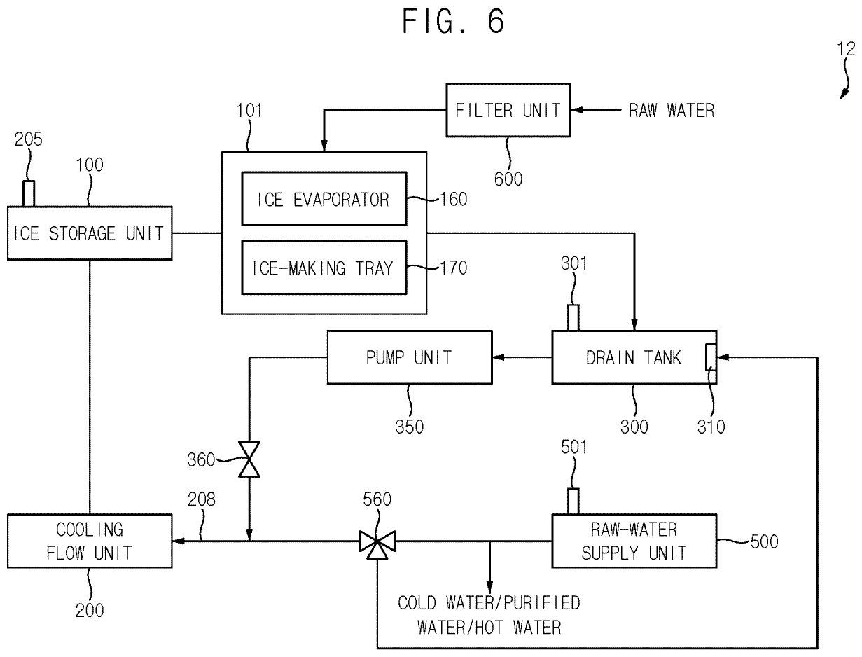

FIG. 6 is a schematic view illustrating an ice water purifier according to still another example embodiment of the present invention.

The ice water purifier 12 according to the present example embodiment is substantially the same as the ice water purifier 10 described with reference to FIG. 1, except that a raw-water supply unit 500 is additionally provided. Therefore, the same reference numerals are used for identical components, and redundant descriptions will be omitted.

Referring to FIG. 6, in the ice water purifier 12 of the present example embodiment, raw water may also be selectively supplied as the ice-making water 208 through the raw-water supply unit 500.

The raw-water supply unit 500 may include, for example, a separate raw-water tank, and the raw water stored in the raw-water tank may be supplied as the ice-making water 208. Alternatively, the raw-water supply unit 500 may be a type in which raw water is supplied directly from an external source without a separate storage tank.

The raw-water supply unit 500 includes a fourth sensor unit 501, and the fourth sensor unit 501 measures the temperature of the raw water supplied from the raw-water supply unit 500. Based on the temperature of the ice storage unit 100 measured by the first sensor unit 205, the temperature of the remaining ice-making water measured by the second sensor unit 301, and the temperature of the raw water measured by the fourth sensor unit 501, the water to be supplied as the cooling water 208 is determined.

That is, if the temperature of the ice storage unit 100 is the lowest, the supply of cooling water may be omitted, and the first valve 360 and a third valve 560 provided between the raw-water supply unit 500 and the cooling flow unit 200 are shut off.

If the temperature of the remaining ice-making water is the lowest, the first valve 360 is opened while the third valve 560 is shut off, so that the remaining ice-making water is supplied to the cooling flow unit 200.

Furthermore, if the temperature of the raw water is the lowest, the first valve 360 is shut off and the third valve 560 is opened so that the raw water is supplied to the cooling flow unit 200. A case in which the raw water has the lowest temperature may typically occur during winter.

As described above and with reference to FIG. 5, the third valve 560 may be, for example, a three-way valve. Thus, the raw water from the raw-water supply unit 500 may be supplied directly to the cooling flow unit 200 or may bypass the drain tank 300 before being supplied to the cooling flow unit 200.

When the raw-water supply unit 500 includes a raw-water tank that stores raw water, the structure inherently includes a separate pump unit, enabling direct supply of raw water to the cooling flow unit 200. Accordingly, in such structures, the third valve 560 opens the flow path toward the cooling flow unit 200 so that raw water may be supplied directly from the raw-water supply unit 500 to the cooling flow unit 200.

Alternatively, when the raw-water supply unit 500 is merely a direct-supply type without a storage tank, it does not include a separate pump unit, and raw water flows according to the supply pressure of water provided from outside. In regions with sufficiently high raw-water pressure, raw water may be directly supplied to the cooling flow unit 200 when cooling is required. However, in regions with low raw-water pressure, the third valve 560 opens the flow path toward the drain tank 300 so that raw water is first delivered from the raw-water supply unit 500 to the drain tank 300, and the pump unit 350 provided in the drain tank 300 supplies the raw water to the cooling flow unit 200. For this purpose, the first valve 360 must also be opened when raw water is supplied.

As described above, in the present example embodiment, when the remaining ice-making water or the raw water has a lower temperature than the temperature of the ice storage unit 100, the lower-temperature water among the remaining ice-making water and the raw water is supplied as the cooling water 208, thereby further enhancing the cooling and insulation performance with respect to the ice storage unit 100.

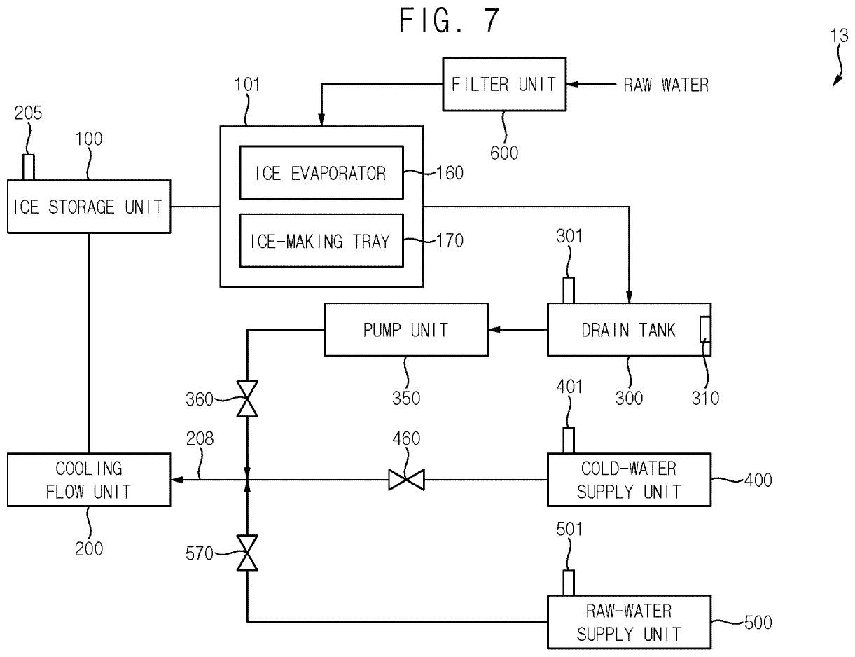

FIG. 7 is a schematic view illustrating an ice water purifier according to still another example embodiment of the present invention.

The ice water purifier 13 according to the present example embodiment is substantially the same as the ice water purifier 11 described with reference to FIG. 5, except that a raw-water supply unit 500 is additionally provided. Therefore, the same reference numerals are used for identical components, and redundant descriptions will be omitted.

Referring to FIG. 7, in the ice water purifier 13 of the present example embodiment, raw water may also be selectively supplied as the ice-making water 208 through the raw-water supply unit 500 in addition to the cold-water supply unit 400.

In this case, the cold-water supply unit 400 and the raw-water supply unit 500 may include separate storage tanks or may be direct-supply types. As previously described, when the units are direct-supply types, bypass supply to the drain tank 300 is also possible. However, the following description omits such bypass operations and illustrates the case in which cold water and raw water are directly supplied to the cooling flow unit 200. It is obvious that the bypass-supply method described with reference to FIG. 5 and FIG. 6 may be identically applied when bypass supply is performed.

The raw-water supply unit 500 includes a fourth sensor unit 501, which measures the temperature of the raw water provided from the raw-water supply unit 500. Based on the temperature of the ice storage unit 100 measured by the first sensor unit 205, the temperature of the remaining ice-making water measured by the second sensor unit 301, the temperature of the cold water measured by the third sensor unit 401, and the temperature of the raw water measured by the fourth sensor unit 501, the supply of water as the cooling water 208 is determined.

That is, if the temperature of the ice storage unit 100 is the lowest, the supply of cooling water is omitted, and the first valve 360, the second valve 460, and a third valve 570 provided between the raw-water supply unit 500 and the cooling flow unit 200 are shut off.

If the temperature of the remaining ice-making water is the lowest, the first valve 360 is opened while the second valve 460 and the third valve 570 are shut off, so that the remaining ice-making water is supplied to the cooling flow unit 200.

If the temperature of the cold water is the lowest, the second valve 460 is opened while the first valve 360 and the third valve 570 are shut off, so that the cold water is supplied to the cooling flow unit 200.

If the temperature of the raw water is the lowest, the third valve 570 is opened while the first valve 360 and the second valve 460 are shut off, so that the raw water is supplied to the cooling flow unit 200.

As described above, in the present example embodiment, when ice-making water 208 must be supplied to the ice storage unit 100, the water having the lowest temperature among the remaining ice-making water, the cold water, and the raw water may be supplied as the cooling water 208. In particular, in the present example embodiment, valves are provided in the pipelines for supplying the remaining ice-making water, the cold water, and the raw water, and the selective supply of ice-making water, cold water, and raw water may be implemented through opening and closing operations of the respective valves.

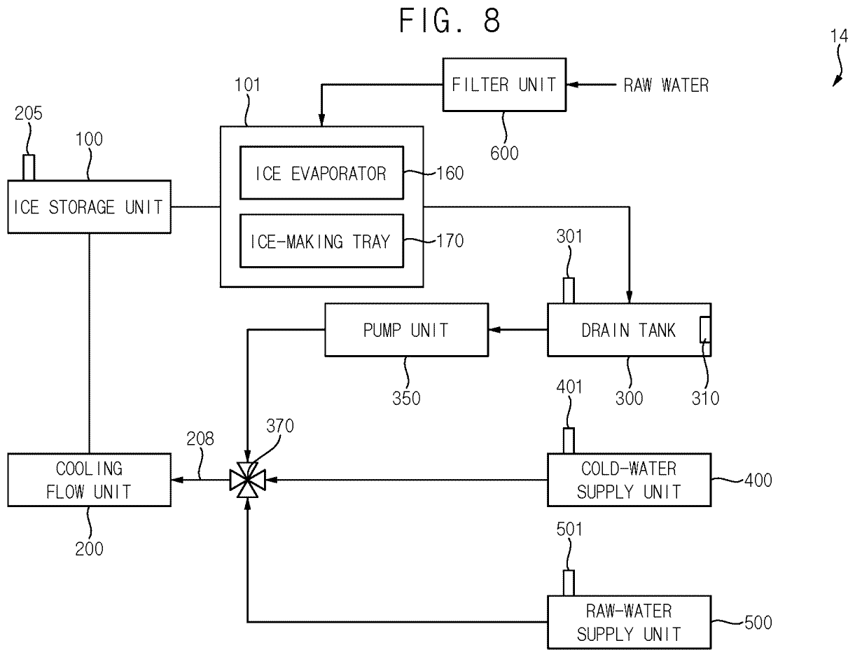

FIG. 8 is a schematic view illustrating an ice water purifier according to still another example embodiment of the present invention.

The ice water purifier 14 according to the present example embodiment is substantially the same as the ice water purifier 13 described with reference to FIG. 7, except that the valve unit is provided as a four-way valve. Therefore, the same reference numerals are used for identical components, and redundant descriptions will be omitted.

That is, in the ice water purifier 14 of the present example embodiment, the cold-water supply unit 400 and the raw-water supply unit 500 are additionally provided in addition to the drain tank 300. Accordingly, when ice-making water 208 must be supplied to the ice storage unit 100, the water having the lowest temperature among the remaining ice-making water, the cold water, and the raw water is supplied as the cooling water 208.

Unlike the case in which first to third valves 360, 460, and 570 are respectively provided in the ice-making-water supply line, the cold-water supply line, and the raw-water supply line to individually control opening and closing operations, a single valve unit is provided as a four-way valve 370.

The four-way valve 370 is connected to the drain tank 300, the cold-water supply unit 400, and the raw-water supply unit 500, and to the cooling flow unit 200, and selectively opens a specific flow path.

Accordingly, if the temperature of the ice storage unit 100 is the lowest, the four-way valve 370 blocks all paths so that the supply of cooling water is stopped.

If the temperature of the remaining ice-making water is the lowest, the four-way valve 370 opens only the path between the drain tank 300 and the cooling flow unit 200 so that the remaining ice-making water is supplied to the cooling flow unit 200.

If the temperature of the cold water is the lowest, the four-way valve 370 opens only the path between the cold-water supply unit 400 and the cooling flow unit 200 so that the cold water is supplied to the cooling flow unit 200.

If the temperature of the raw water is the lowest, the four-way valve 370 opens only the path between the raw-water supply unit 500 and the cooling flow unit 200 so that the raw water is supplied to the cooling flow unit 200.

As described above, by selectively opening a specific path through the four-way valve 370, the control of supplying the cooling water 208 to the cooling flow unit 200 may be implemented more easily.

According to exemplary embodiments of the present invention, a cooling flow unit is formed along an outer surface or side surfaces of the ice storage unit in which ice is stored, and as cooling water having a relatively low temperature flows through the cooling flow unit, the insulation effect of the ice storage unit may be improved through direct cooling.

Accordingly, compared to techniques that merely fill or cover the exterior of the ice storage unit with insulation material, the ice water purifier enables more direct cooling or insulation, and even when various structures or holes are formed in the ice storage unit and heat intrusion increases, the cooling or insulation effect may still be enhanced.

In this case, the cooling flow unit may extend in a zigzag pattern so as to contact a larger surface area of the ice storage unit, and the cooling water may be introduced from a side having a relatively higher temperature, thereby increasing the insulation effect through cooling of the higher-temperature region.

In addition, the cooling flow unit may extend across at least two of the side surfaces of the ice storage unit to form a single flow path, allowing the inflow and outflow of the cooling water to be controlled in a simplified manner. Alternatively, an independent cooling flow unit may be formed on each side surface, thereby improving ease of installation of the cooling flow unit.

Further, when a filling portion is additionally formed outside the cooling flow unit, the cooling energy provided through the cooling flow unit may be guided toward the ice storage unit rather than outward, thereby further enhancing the insulation effect. The filling portion may include a vacuum portion, insulation material, or an insulation structure, allowing the filling portion to be optimized according to various structural configurations. Particularly, by forming a fin portion on the outer surface of the ice storage unit to increase the contact area with the cooling flow unit, the transfer efficiency of cooling energy to the ice storage unit may be further improved.

Meanwhile, the cooling water supplied to the cooling flow unit may selectively be ice-making water, cold water, or raw water, allowing cooling water of the lowest available temperature to be provided depending on the usage state or season, thereby improving energy efficiency.

Notably, in selecting among the ice-making water, cold water, and raw water, temperatures measured by sensor units provided in the drain tank, the cold-water supply unit, and the raw-water supply unit may be compared with the temperature of the ice storage unit, so that the cooling water having the lowest temperature can be selected.

Additionally, a water level sensor unit may be provided in the drain tank so that the amount of cooling water supplied to the cooling flow unit may be appropriately controlled based on the water level of the drain tank.

The cold-water supply unit may be a cold-water tank that stores cold water or may be a direct-cooling type or an ice-storage type that directly produces and supplies cold water, allowing the cold water to be used as cooling water regardless of the cold-water supply structure of the purifier.

In this case, when the cold-water supply unit is a direct-cooling or ice-shaft type, no separate pump unit is included in the cold-water supply unit. Thus, by bypassing the cold water so that it passes through the drain tank before being supplied as cooling water, the cooling water may be supplied through a pump unit provided in the drain tank, eliminating the need for a separate pump unit in the cold-water supply unit.

Furthermore, the supply of the ice-making water, cold water, or raw water may be controlled through separate valves, or may alternatively be selectively controlled through a single four-way valve, allowing various piping system configurations and improving design flexibility.

Having described exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. An ice water purifier comprising:
a filter unit configured to receive raw water and generate purified water;
an ice-making unit configured to generate ice using the purified water generated by the filter unit;
an ice storage unit configured to store the ice generated by the ice-making unit; and
a cooling flow unit configured to extend along an outer surface of the ice storage unit and to receive cooling water that remains stagnant or flows within an interior thereof.

2. The ice water purifier of claim 1, wherein the cooling flow unit is configured to extend in a zigzag pattern along the outer surface.

3. The ice water purifier of claim 1, wherein the ice storage unit comprises a first side and a second side that face each other in a first direction, and a third side and a fourth side that face each other in a second direction.

4. The ice water purifier of claim 3, wherein the cooling flow unit is configured to extend continuously along at least two of the first side through the fourth side.

5. The ice water purifier of claim 4, wherein the cooling flow unit comprises:
an inlet formed on any one of the first side through the fourth side and configured to allow the cooling water to flow in; and
an outlet formed on remaining one of the first side through the fourth side and configured to allow the cooling water to flow out.

6. The ice water purifier of claim 3, wherein the cooling flow unit extends continuously only along any one of the first side through the fourth side, and an inlet configured to receive the cooling water and an outlet configured to discharge the cooling water are simultaneously formed on the same side.

7. The ice water purifier of claim 3, wherein the ice storage unit further comprises a fin portion formed on the side of the first side through the fourth side on which the cooling flow unit is formed such that the fin portion contacts the cooling flow unit.

8. The ice water purifier of claim 1, further comprising a filling portion configured to cover the ice storage unit on which the cooling flow unit is formed.

9. The ice water purifier of claim 8, wherein the filling portion comprises:
a vacuum portion configured to maintain the cooling flow unit in a vacuum state; or
insulation material configured to cool the cooling flow unit; or
an insulation portion configured to contact the cooling flow unit and insulation material configured to cover an outer surface of the insulation portion.

10. The ice water purifier of claim 1, further comprising a drain tank configured to store remaining ice-making water drained from the ice storage unit.

11. The ice water purifier of claim 10, further comprising a water level sensor unit configured to measure a water level of the drain tank,
wherein an amount of the remaining ice-making water provided to the cooling flow unit is controlled based on the water level of the drain tank.

12. The ice water purifier of claim 10, wherein the cooling water is any one of:
the remaining ice-making water drained from the ice storage unit,
cold water provided through a cold-water supply unit, and
raw water provided through a raw-water supply unit.

13. The ice water purifier of claim 12, wherein the cold water of the cold-water supply unit passes through the drain tank and is provided to the cooling flow unit.

14. The ice water purifier of claim 12, wherein the raw water of the raw-water supply unit passes through the drain tank and is provided to the cooling flow unit.

15. The ice water purifier of claim 12, further comprising a first valve configured to control supply of the ice-making water, a second valve configured to control supply of the cold water, and a third valve configured to control supply of the raw water.

16. The ice water purifier of claim 12, wherein the ice-making water, the cold water, and the raw water are selectively provided through control of a four-way valve.

17. The ice water purifier of claim 12, wherein the cooling water is intermittently provided to the cooling flow unit.

18. The ice water purifier of claim 12, further comprising:
a first sensor unit configured to measure a temperature of the ice storage unit; and
a second sensor unit configured to measure a temperature of the remaining ice-making water in the drain tank,
wherein, when the temperature of the remaining ice-making water is lower than the temperature of the ice storage unit, the remaining ice-making water is provided to the cooling flow unit.

19. The ice water purifier of claim 18, further comprising a third sensor unit configured to measure a temperature of the cold water of the cold-water supply unit,
wherein, when the temperature of the cold water is lower than the temperature of the ice storage unit and a temperature of the ice-making water, the cold water is provided to the cooling flow unit.

20. The ice water purifier of claim 19, further comprising a fourth sensor unit configured to measure a temperature of the raw water of the raw-water supply unit,
wherein, when the temperature of the raw water is lower than the temperature of the ice storage unit, the temperature of the ice-making water, and the temperature of the cold water, the raw water is provided to the cooling flow unit.
